(19) United States
(12) Patent Application Publication
(10) Pub. No.: US 2012/0208063 A1
(43) Pub. Date: Aug. 16, 2012

(54) LIQUID COOLED DEVICE FOR BATTERIES

(75) Inventors: Peng Zhou, El Cerrito, CA (US); Paul Tsao, Los Altos, CA (US)

(73) Assignee: SINOELECTRIC POWERTRAIN CORPORATION, Sunnyvale, CA (US)

(21) Appl. No.: 13/028,942

(22) Filed: Feb. 16, 2011

(51) Int. Cl. H01M 10/50

(52) U.S. Cl. 429/120

(57) ABSTRACT

A battery liquid temperature regulating device includes one or more battery cells thermally coupled to one or more temperature regulating modules. A first temperature regulating module is thermally coupled to one end of each battery cell, and in some embodiments, a second temperature regulating module is thermally coupled to the other end of each battery cell. Each temperature regulating module is configured with one or more channels. Heat is transferred between each battery cell end, the material of the temperature regulating module, and the liquid flowing through the one or more channels. The temperature regulating modules are also thermally coupled to current collecting elements electrically coupled to the battery cell to similarly transfer heat between these elements.

### FIELD OF THE INVENTION

The present invention relates to the field of batteries. More particularly, the present invention relates to the field of liquid based devices used for cooling or heating batteries.

### BACKGROUND OF THE INVENTION

A battery is a device that converts chemical energy to electrical energy. The battery is a combination of one or more electrochemical cells, each cell consists of two half-cells connected in series by a conductive electrolyte. One half-cell includes electrolyte and an electrode to which negatively-charged ions migrate, for example the anode or negative electrode. The other half-cell includes electrolyte and an electrode to which positively-charged ions migrate, for example the cathode or positive electrode. The electrodes do not touch each other but are electrically connected by the electrolyte. Many cells use two half-cells with different electrolytes. In this configuration, each half-cell is separated by a separator. The separator is porous to ions, but not the electrolytes, thereby enabling ions to pass but preventing mixing of the electrolytes between the two half-cells.

A battery pack is a connected set of battery cells. Battery cells can be configured in series, parallel, or a mixture of both to deliver the desired voltage, capacity, or power density. Components of a battery pack include the individual battery cells and the interconnects which provide electrical conductivity between them. In many battery packs, current collector plates are used to collect the current output from each of the battery cells in the battery pack. A first current collector plate is connected to the anodes of each of the battery cells, and a second current collector plate is connected to the cathodes of each of the battery cells.

Batteries are designed to operate within specified temperature ranges. Increasing temperature results in increasing electrical resistance and inhibited current flow. As such, management of battery temperature is desired.

### SUMMARY OF THE INVENTION

Embodiments of a battery liquid cooling device include one or more battery cells thermally coupled to one or more cooling modules. Although described herein as a liquid cooling device and a cooling module used to cool a battery cell, the liquid cooling device and the cooling module can generally be referred to as a liquid temperature regulating device and a temperature regulating module, respectively, that can also be used to heat a battery cell, such as in cold climates. In some embodiments, the one or more battery cells are secured within a battery cell holder having at least a first opening for access to one end of each battery cell and a second opening for access to the second end. In other embodiments, a battery cell holder is not used. Instead, the one or more cooling modules are used as both cooling devices and support structures. A first cooling module is thermally coupled to one end of each battery cell, and in some embodiments, a second cooling module is thermally coupled to the other end of each battery cell. Each cooling module is configured with one or more channels positioned proximate each battery cell end coupled to the cooling module. Heat from each battery cell end is transferred to the material of the cooling module and into liquid flowing through the one or more channels. The heated liquid is output from the cooling module, cooled, and returned to the cooling module. In some embodiments, the cooling modules are also thermally coupled to current collecting elements and/or conductive elements electrically coupled to the battery cell to similarly remove heat from these elements.

In one aspect, a battery cooling module includes a channel component made of a thermally conductive material, wherein the channel component comprises one or more first openings, each first opening configured to receive an end of a battery cell such that the end of the battery cell is thermally coupled to the channel component, further wherein the channel component further comprises at least one liquid inlet port, at least one liquid outlet port, and one or more channels coupled between the at least one liquid inlet port and the at least one liquid outlet port through which liquid flows such that heat is transferred between the end of the battery cell and the liquid flowing through the one or more channels; and a cover component coupled to the channel component such that the one or more channels are sealed except for the at least one liquid inlet port and the at least one liquid outlet port. In some embodiments, the one or more first openings and the one or more channels are formed on a first surface of the channel component, further wherein the channel component includes a second surface thermally coupled to a current collector element such that heat is transferred between the current collector element and the liquid flowing through the one or more channels. In some embodiments, the channel component further comprises an indent formed in the second surface, wherein the indent is configured to receive the current collector element. In some embodiments, the channel component further comprises a second opening formed in the second surface, wherein the second opening is smaller than the first opening, and the second opening is aligned with the first opening and the first end of the battery cell. The channel component can be sealed to the cover component using one of a group consisting of glue, ultrasonic welding, hot plate welding, and vibration welding.

In another aspect, a battery temperature regulating device includes a battery cell including a first end having a first electrode and a second end having a second electrode; and a temperature regulating module made of a thermally conductive material, wherein the temperature regulating module comprises a first opening configured to receive the first end of the battery cell such that the first end of the battery cell is thermally coupled to the temperature regulating module, further wherein the temperature regulating module further comprises at least one liquid inlet port, at least one liquid outlet port, and one or more channels coupled between the at least one liquid inlet port and the at least one liquid outlet port, heat is transferred between the first end of the battery cell and a liquid flowing through the one or more channels. In some embodiments, the battery temperature regulating device also includes a battery cell holder configured to support the battery cell, wherein the battery cell holder is coupled to the temperature regulating module. In this embodiment, the first end of the battery cell can extend out of the battery cell holder. In some embodiments, the battery temperature regulating device also includes a first current collector element electrically coupled to the first electrode of the battery cell, and a second current collector element electrically coupled to the second electrode of the battery cell. The first current collector element can be thermally coupled to the temperature regulating module such that heat is transferred between the first current collector element and the liquid flowing through the one or more channels in the temperature regulating module. The first current collector element can be a current collector conductor pad, a current collector conductor plate, a current collector conductor fuse sheet, or any combination thereof. The temperature regulating module can include a first surface having an indent configured to receive the first current collector element. The first current collector element can be coupled to a first output terminal, and the second current collector conductive element can be coupled to a second output terminal.

In some embodiments, the temperature regulating module comprises a first surface including the first opening and a second surface opposite the first surface, the second surface including a second opening smaller than the first opening, wherein the second opening is aligned with first electrode of the battery cell. In some embodiments, the temperature regulating module comprises a channel component including the at least one liquid inlet port, the at least one liquid outlet port, and the one or more channels, and a cover component sealed to the channel component such that the one or more channels are sealed except for the at least one liquid inlet port and the at least one liquid outlet port. In this embodiment, the channel component can be sealed to the cover component using one of a group consisting of glue, ultrasonic welding, hot plate welding, and vibration welding. In some embodiments, the battery temperature regulating device also includes a second temperature regulating module made of a thermally conductive material, wherein the second temperature regulating module comprises a first opening configured to receive the second end of the battery cell such that the second end of the battery cell is thermally coupled to the second temperature regulating module, further wherein the second temperature regulating module further comprises at least one liquid inlet port, at least one liquid outlet port, and one or more channels coupled between the at least one liquid inlet port and the at least one liquid outlet port, heat is transferred between the second end of the battery cell and a liquid flowing through the one or more channels in the second temperature regulating module. In this embodiment, the battery temperature regulating device can also include a battery cell holder configured to support the battery cell, wherein the battery cell holder is coupled to the temperature regulating module and the second temperature regulating module. The second end of the battery cell can extend out of the battery cell holder and into the corresponding first opening of the second temperature regulating module.

In yet another aspect, a battery pack is configured including a plurality of battery cells, each battery cell including a first end having a first electrode and a second end having a second electrode; and a temperature regulating module made of a thermally conductive material, wherein the temperature regulating module comprises a plurality of first openings, each first opening configured to receive the first end of a corresponding one of the plurality of battery cells such that the first end of each battery cell is thermally coupled to the temperature regulating module, further wherein the temperature regulating module further comprises at least one liquid inlet port, at least one liquid outlet port, and one or more channels coupled between the at least one liquid inlet port and the at least one liquid outlet port, heat is transferred between the first end of each battery cell and a liquid flowing through the one or more channels.

### BRIEF DESCRIPTION OF THE DRAWINGS

FIG. 1A illustrates an isometric view of a structure for holding and cooling a battery cell according to an embodiment.

FIG. 1B illustrates an isometric view of a structure for holding and cooling a battery cell according to an alternative embodiment.

FIG. 2 illustrates an isometric view of the battery cell holder of FIG. 1 holding a battery cell.

FIG. 3 illustrates an isometric view of the cooling module of FIG. 1 according to an embodiment.

FIG. 4 illustrates an isometric view of the cooling module having two components according to an embodiment.

FIG. 5 illustrates a top down view of the channel component of FIG. 4.

FIG. 6 illustrates a cut out side view of the structure of FIG. 1 including conducting elements electrically coupled to the battery cell according to an embodiment.

FIG. 7 illustrates an isometric view of a structure for holding and cooling a battery cell having a single cooling module according to an embodiment.

FIG. 8 illustrates an isometric view of a cooling module having an indent according to an embodiment.

FIG. 9 illustrates an isometric view of a structure for holding and cooling multiple battery cells according to an embodiment.

FIG. 10 illustrates the battery cell holder of FIG. 9.

FIG. 11 illustrates a current collector plate according to an embodiment.

FIG. 12 illustrates a cut out side view of a battery pack along two of the battery cells according to an embodiment.

FIG. 13 illustrates a bottom up view of the channel component of FIG. 12.

FIG. 14 illustrates an isometric view of a cooling module for multiple battery cells having an indent according to an embodiment.

FIG. 15 illustrates a cut out side view of a battery pack including fuse sheets according to an embodiment.

Embodiments of the battery liquid cooling device are described relative to the several views of the drawings. Where appropriate and only where identical elements are disclosed and shown in more than one drawing, the same reference numeral will be used to represent such identical elements.

### DETAILED DESCRIPTION OF THE EMBODIMENTS

Embodiments of the present application are directed to a battery liquid cooling device. Those of ordinary skill in the art will realize that the following detailed description of the battery liquid cooling device is illustrative only and is not intended to be in any way limiting. Other embodiments of the battery liquid cooling device will readily suggest themselves to such skilled persons having the benefit of this disclosure.

Reference will now be made in detail to implementations of the battery liquid cooling device as illustrated in the accompanying drawings. The same reference indicators will be used throughout the drawings and the following detailed description to refer to the same or like parts. In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

A battery liquid cooling device is configured to remove heat from one or more battery cells. A battery cell is thermally coupled to one or more cooling modules. A battery cell includes an anode electrode and a cathode electrode. In some embodiments, each of the one or more cooling modules also functions as a support structure for holding the battery cell in place. In other embodiments, the battery cell is secured within a battery cell holder having at least a first opening for access to the anode electrode and a second opening for access to the cathode electrode. A first cooling module is thermally coupled to one end of the battery cell, and in some embodiments, a second cooling module is thermally coupled to the other end of the battery cell. Each cooling module is configured with at least one liquid inlet port and at least one liquid outlet port. One or more channels configured within the cooling module are coupled to the inlet and outlet ports to transport liquid. In some embodiments, the channels are positioned proximate the battery cell end coupled to the cooling module. Heat from the battery cell end is transferred to the material of the cooling module and into liquid flowing through the channels. The heated liquid is output from the cooling module via the liquid outlet port, cooled, and returned to the cooling module via the liquid inlet port. In this manner, heat is removed from the battery cell. In some embodiments, the cooling modules are also thermally coupled to current collecting elements and/or conductive elements electrically coupled to the battery cell to similarly remove heat from these elements. The battery liquid cooling device is described as cooling the battery cell by transferring heat from the battery cell to the liquid. Alternatively, the battery liquid cooling device can be configured to heat the battery cell by transferring heat from the liquid to the battery cell.

In some embodiments, multiple battery cells are electrically connected as a battery pack. One or more cooling modules are included in the battery pack to remove heat from the multiple battery cells, and in some embodiments, remove heat from current collecting elements and/or conductive elements electrically coupled to the multiple battery cells.

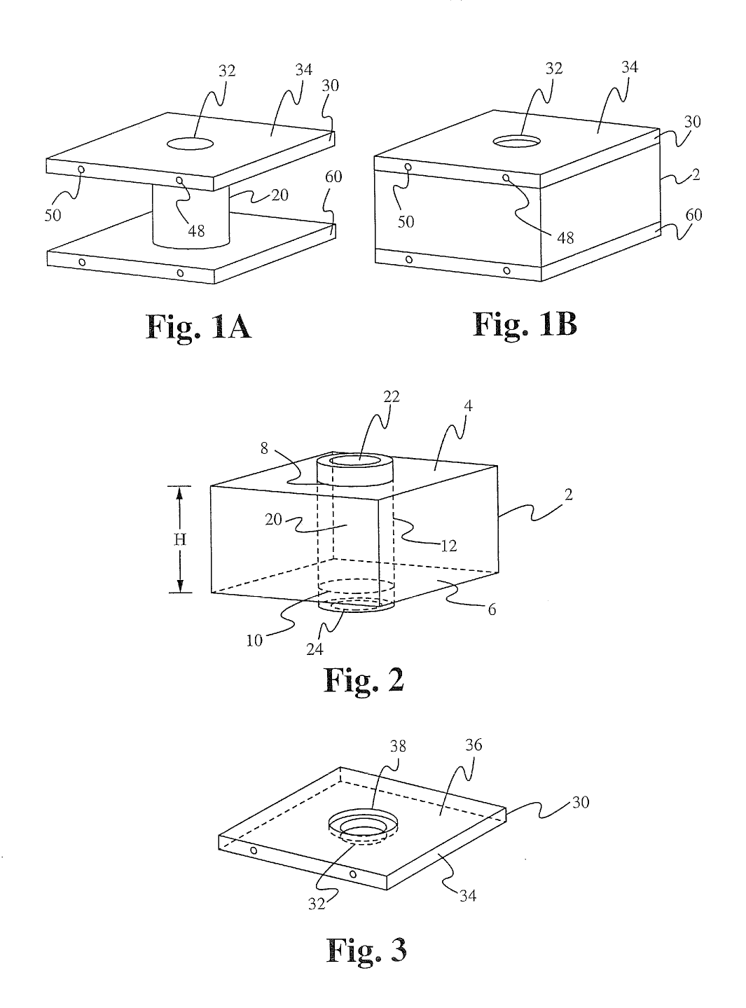

FIG. 1A illustrates an isometric view of a structure for holding and cooling a battery cell according to an embodiment. The structure includes a cooling module 30 and a cooling module 60. The cooling module 30 includes an opening 32 at a surface 34. The cooling module 30 also includes at least one liquid inlet port 48 and at least one liquid outlet port 50. The cooling module 60 is similarly configured as the cooling module 30. For simplicity, only the cooling module 30 is described in detail below, although it is understood that such discussion also applies to the configuration and function of the cooling module 60. In some embodiments, the cooling module 30 and the cooling module 60 also function as support structures for holding a battery cell 20 in place. In other embodiments, the structure includes a battery cell holder 2, such as in FIG. 1B, for supporting the battery cell.

FIG. 2 illustrates an isometric view of the battery cell holder of FIG. 1B holding a battery cell. The battery cell holder 2 includes a battery cell chamber 12 that has a form factor suitable for accommodating the battery cell 20 within. The form factor of the battery cell chamber 12 is form fitting to the battery cell 20 so as to minimize or prevent movement of the battery cell 20 relative to the battery cell holder 2. A first surface 4 of the battery cell holder 2 includes an opening 8, and a second surface 6 includes an opening 10. The openings 8 and 10 are aligned with the battery cell chamber 12, and in particular are aligned with an anode electrode and a cathode electrode of a battery cell positioned within the battery cell chamber 12. As shown in FIG. 2, a height H of the battery cell holder 12 is less than a length of the battery cell 20 to be positioned within the battery cell chamber 12 such that a first end of the battery cell 20 including a first electrode 22 extends out of the opening 8 beyond the surface 4, and a second end of the battery cell 20 including a second electrode 24 extends out of the opening 10 beyond the surface 6. In some embodiments, the battery cell holder 2 is made of an electrically resistant and thermally conductive material. In some embodiments, one or more of the side surfaces of the battery cell holder 2 are configured so as to enable access to the battery cell chamber 12 for repair or replacement of a battery cell. For example, the first surface 4 and/or the second surface 6 are panels that are attached using screws, latches, or hinges.

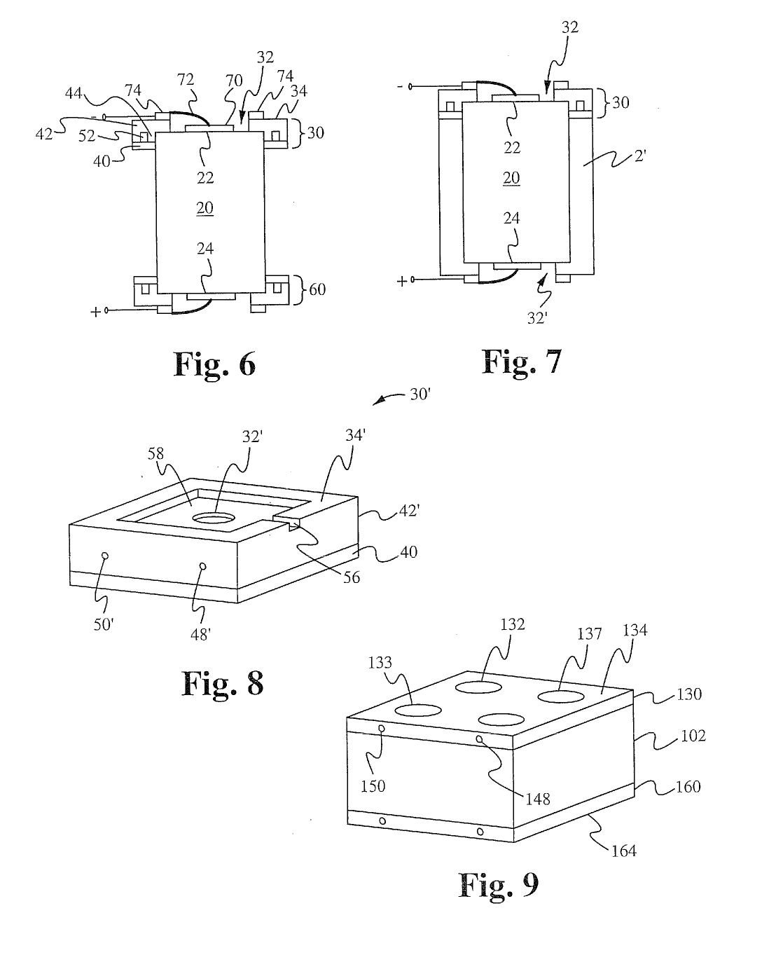

FIG. 3 illustrates an isometric view of the cooling module 30 of FIGS. 1A and 1B according to an embodiment. The view of the cooling module 30 shown in FIG. 3 is the flip side of the view shown in FIGS. 1A and 1B. The orientation of the cooling module 30 shown in FIG. 3 is the same as the orientation of the cooling module 60 shown in FIGS. 1A and 1B. The cooling module 30 includes an opening 38 in a surface 36. The surface 36 is coupled to the surface 4 (FIG. 2) of the battery cell holder 2 (FIG. 2) when assembled as in FIG. 1B. A diameter of the opening 38 is larger than a diameter of the opening 32. The diameter of the opening 32 is large enough to expose the entire diameter of the first electrode 22. The diameter of the opening 38 is equal to a diameter of the opening 8 (FIG. 2) of the battery cell holder 2 (FIG. 2), when the battery cell holder 2 is used. When assembled, the first end of the battery cell 20 including the first electrode fits within the opening 38, as shown in the cut out side view of FIG. 6. The first end of the battery 20 fits within the opening 38 such that the first end of the battery cell 20 is thermally coupled to the material forming the cooling module 30. The first end of the battery cell 20 is thermally coupled to the cooling module 30 vi either direct contact or through a conventional thermal interface material including, but not limited to, a thermal grease or thermal epoxy. The cooling module 60 is similarly coupled to the second end of the battery cell 20, and where appropriate to a surface 6 (FIG. 2) of the battery cell holder 2 (FIG. 2).

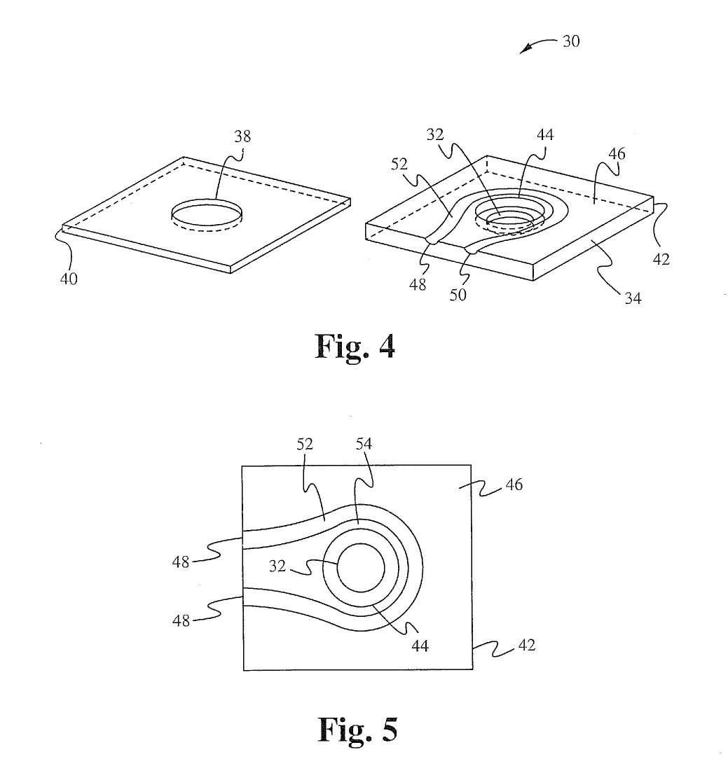

In some embodiments, the cooling module 30 is formed from two separate components sealed together. FIG. 4 illustrates an isometric view of the cooling module 30 having two components according to an embodiment. The cooling module 30 includes a cover component 40 coupled to a channel component 42, shown separated in FIG. 4. The cover component 40 includes the opening 38 that extends through the entire thickness of the cover component 40. The channel component 42 includes an opening 44 in a surface 46. The opening 44 has a diameter that is equal to the diameter of the opening 38. The opening 44 in the channel component 42 is aligned with the opening 38 in the channel component 42 such that the first end of the battery cell 20 including the first electrode 22 extends through the opening 38 in the cover component 40 and into the opening 44 in the channel component 42. The channel component 42 includes the opening 32 in the surface 34, which is opposite of the surface 46.

The channel component 42 also includes a channel 52 formed into the surface 46. FIG. 5 illustrates a top down view of the channel component 42 of FIG. 4. The channel 52 includes the liquid inlet port 48 and the liquid outlet port 50. A portion of the channel 52 is positioned proximate the perimeter of the opening 44 such that a wall 44 is formed between the opening 44 and the channel 52. In some embodiments, the opening 44 is circular, and the portion of the channel 52 forms a partial ring around a portion of the opening 44. A thickness of the wall 44 is application specific.

In operation, liquid flows into the channel 52 via the liquid inlet port 48 and out of the channel 52 via the liquid outlet port 50. The cover component 40 is sealed to the channel component 42 thereby sealing the channel 52 except for the liquid inlet port 48 and the liquid outlet port 50. As liquid flows through the channel 52, heat from battery cell 20 is transferred from the first end of the battery cell 20 to the material of the channel component 42, including the wall 44, and into the liquid. In some embodiments, the liquid inlet port 48 and the liquid outlet port 50 are coupled to a liquid cooling loop whereby heated liquid output through the liquid outlet port 50 is cooled and input to the liquid inlet port 48. The channel component 42 and the cover component 40 are made of a thermally conductive material. In some embodiments, the channel component and the cover component are made of plastic. Various methods can be used to seal the cover component to the channel component. Methods for sealing a cover component to a channel component include, but are not limited to, glueing, ultrasonic welding, hot plate welding, and vibration welding.

FIG. 6 illustrates a cut out side view of the structure of FIG. 1 including conducting elements electrically coupled to the battery cell 20 according to an embodiment. The openings 38 and 32 form a through-hole through a thickness of the cooling module 30. The through-hole has a diameter equal to the diameter of the opening 38 for a first portion of the thickness of the cooling module 30, and the through-hole has a diameter equal to the diameter of the opening 32 for a second portion of the thickness of the cooling module 30. The through-hole provides access to the first electrode 22 of the battery cell 20. A through-hole in the cooling module 60 provides access to the second electrode 24 of the battery cell 20. The first electrode 22 is electrically coupled to a negative terminal via a first conducting element, and the second electrode 24 is electrically coupled to a positive terminal via a second conducting element. In some embodiments, the first conducting element includes a battery cell conductor pad 70, a conductor 72, and a current collector conductor pad 74. The battery cell conductor pad 70 is coupled to the first electrode 22. In some embodiments, the battery cell conductor pad 70, the conductor 72, and the current collector conductor pad 74 are integrally connected. As shown in FIG. 6, the cooling modules 30 and 60 also provide support for the battery cell 20. In other embodiments, a battery cell holder, such as the battery cell holder 2 in FIG. 2, can be positioned between the cooling module 30 and the cooling module 60.

In some embodiments, the conductor 72 is a fusible link that melts under excessive current. A fusible link is a type of electrical fuse that functions as a current interrupt device. The fusible link is typically a short piece of relatively thin metal wire or strip that melts when excessive current is applied, which interrupts the connection between the battery cell and the current collector pad. Short circuit, overload, or device failure is often the reason for excessive current. The size and construction of the fusible link is determined so that the heat produced for normal current does not cause the wire to melt and open the circuit. In some embodiments, the fusible link is a flexible fusible link that provides excessive length for accommodating relative movement of the battery cell 20 and a current collector element, such as a current collector conductor pad 74. An example of such a flexible fusible link is described in U.S. patent application Ser. No. 12/779,884, filed on May 13, 2010, and titled “Flexible Fusible Link, Systems, and Methods”, which is hereby incorporated in its entirety by reference. In other embodiments, the conductor 72 is a non-fusible link.

The battery cell conductor pad 70 of the first conducting element is electrically and mechanically coupled to the first electrode 22. The current collector conductor pad 74 is mechanically coupled to the surface 34 of the cooling module 30. The current collector conductor pad 74 is positioned proximate the opening 32 in the cooling module 30. In an exemplary embodiment, the battery cell 20 has a cylindrical shape, the current collector conductor pad 74 has a ring shape, and the battery cell conductor pad 70 has a circular shape. In this configuration, the current collector conductor pad 74 is positioned around the opening 32. The second conducting element is similarly coupled to the cooling module 60 and the second electrode 24. Since the current collector conductor pads are coupled to the cooling modules, heat is transferred from the current collector conductor pads to the liquid flowing through the cooling modules. It is understood by those skilled in the art that the current collector conductor pad can be configured differently than a ring. For example, a current collector plate can be used.

In some embodiments, only a single cooling module is used, such as the cooling module 30. In this embodiment, a battery cell holder can be used to provide additional structural support. In some embodiments, the battery cell holder can be configured with a step-like form factor at one end to match a contour of the second end of the battery cell 20, such as battery cell holder 2′ in FIG. 7, where the battery cell holder has an opening 32′ similar to the opening 32 to expose the second electrode 24.

Various methods can be used to connect a battery cell conductor pad to a battery cell electrode. Methods for connecting a battery cell conductor pad to a battery cell electrode include, but are not limited to, resistance welding, laser welding, ultrasonic welding, mechanical fasteners, and conductive adhesives. Various method can be used to connect a current collector conductor pad to the cooling module. Methods for connecting a current collector conductor pad to a cooling module include, but are not limited to, adhesives, mechanical fasteners, and welding.

As shown in FIG. 6, the current collector conductor pad 74 is positioned on the surface 34 of the cooling module 30. In alternative embodiments, an indent can be formed in the surface 34 of the cooling module 30 such that the current collector conductor pad 74 fits within the indent. In some embodiments, the indent is formed having a perimeter shape that matches the perimeter shape of the current collector conductor pad such that the current collector conductor pad fits securely within the indent. FIG. 8 illustrates an isometric view of a cooling module having an indent according to an embodiment. The cooling module 30′ is configured similarly as the cooling module 30 except that an indent 58 is formed in a surface 34′ of the cooling module 30′. As shown in FIG. 8, the exemplary shape of the indent 58 is a square, in which case the current collector pad is shaped as a square to fit within the indent 58. It is understood that alternative shapes and sizes of the indent and current collector conductor pad can be used. In some embodiments, the indent 58 includes a channel 56 to accommodate a complimentary extension in the current collector conductor pad. Such an extension further secures the current collector conductor pad within the indent, as well as provides an electrical connection point.

In some embodiments, multiple battery cells are electrically connected as a battery pack. Similar concepts as those described above for a single battery cell configuration are adapted for use with multiple battery cells. FIG. 9 illustrates an isometric view of a structure for holding and cooling multiple battery cells according to an embodiment. The structure includes a cooling module 130 and a cooling module 160. In the embodiment shown in FIG. 9, the structure includes a battery cell holder 102. It is understood that the battery cell holder 102 is optional, and that the structure may not include the battery cell holder 102. The cooling module 130 includes openings 132, 133, 135, and 137 at a surface 134. The cooling module 130 also includes at least one liquid inlet port 148 and at least one liquid outlet port 150. The cooling module 160 is similarly configured as the cooling module 130. For simplicity, only the cooling module 130 is described in detail below, although it is understood that such discussion is also applied to the configuration and function of the cooling module 160. The structure of FIG. 9 is configured to operate similarly as the structure of FIG. 1 except that the structure of FIG. 9 is configured to hold and cool multiple battery cells. Although the structure of FIG. 9 is configured to hold and cool four battery cells, it is understood that the concepts can be extended to apply to more, or less, than four battery cells. As with the single battery cell configuration of the structure of FIG. 1, the structure of FIG. 9 is configured to include two cooling modules. It is understood that a structure for holding and cooling multiple battery cells can be configured with a single cooling module, similarly to the single battery cell structure of FIG. 7. It is further understood that any alternative embodiments described above in regards to the single battery cell structures can be similarly applied to the multiple battery cell structures.

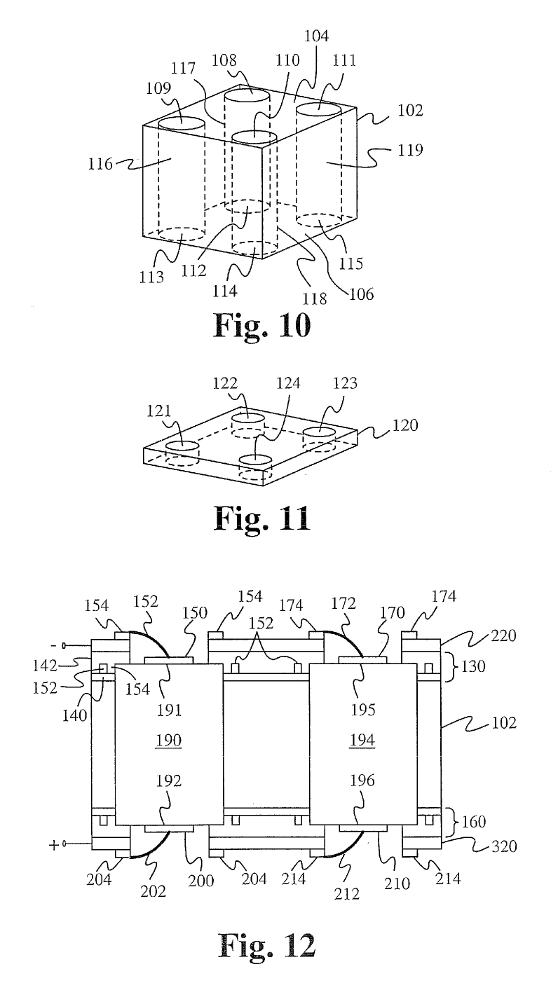

FIG. 10 illustrates the battery cell holder 102 of FIG. 9. The battery cell holder 102 includes a plurality of battery cell chambers 116, 117, 118, 119 each having a form factor suitable for accommodating a battery cell within. The form factor of each battery cell chamber is form fitting to the battery cell so as to minimize or prevent movement of the battery cell relative to the battery cell holder 102. A first surface 104 includes a plurality of openings 108, 109, 110, 111. A second surface 106 includes a plurality of openings 112, 113, 114, 115. The openings 108 and 112 are aligned with the battery cell chamber 117, the openings 109 and 113 are aligned with the battery cell chamber 116, the openings 110 and 114 are aligned with the battery cell chamber 118, and the openings 111 and 115 are aligned with the battery cell chamber 119.

FIG. 11 illustrates a current collector plate according to an embodiment. A current collector plate 120 has plurality of through holes 121, 122, 123, 123. A first current collector plate is configured to be coupled to the surface 134 of the cooling module 130 of FIG. 9, and a second current collector plate is configured to be coupled to a surface 164 of the cooling module 160 of FIG. 9. As such, the number of through holes in the current collector plate 120 matches the number of openings in the surface 134 of the cooling module 130 and in the surface 164 of the cooling module 160. In this exemplary configuration, there are four through holes in the current collector plate. When the current collector plate 120 is coupled to the surface 134 of the cooling module 130, the through hole 121 is aligned with the opening 133, the through hole 122 is aligned with the opening 132, the through hole 123 is aligned with the opening 137, and the through hole 124 is aligned with the opening 135. When the current collector plate 120 is coupled to the surface 164 of the cooling module 160, the through holes 121, 122, 123, 124 are similarly aligned with the openings in the cooling module 160.

FIG. 12 illustrates a cut out side view of a battery pack along two of the battery cells according to an embodiment. The battery pack includes the battery cell holder 102 of FIG. 10, the cooling module 130, a first current collector plate 220 coupled to the cooling module 130, the cooling module 160, and a second current collector plate 320 coupled to the cooling module 160. It is understood that inclusion of the battery cell holder 102 is optional. The first current collector plate 220 and the second current collector plate 320 have the same configuration as the current collector plate 120 of FIG. 11. The battery pack also includes four conducting elements coupling the current collector plate 230 to the first electrodes of the battery cells, and four conducting elements coupling the current collector plate 320 to the second electrodes of the battery cells.

In the embodiment that includes the battery cell holder 102, a battery cell 190 is positioned within the battery cell chamber 116 (FIG. 10) and a battery cell 194 is positioned within the battery cell chamber 118 (FIG. 10). The battery cell 190 has a first electrode 191 and a second electrode 192. The battery cell 194 has a first electrode 195 and a second electrode 196. In an exemplary configuration, the first electrodes 191, 195 are each anode electrodes and the second electrodes 192, 196 are each cathode electrodes. In this configuration, the current collector plate 220 is electrically coupled to a negative terminal, and the second current collector plate 320 is electrically coupled to a positive terminal. A first conducting element is coupled to the current collector plate 220 and to the anode electrode 191 of the battery cell 190. A second conducting element is coupled to the current collector plate 320 and to the cathode electrode 192 of the battery cell 190. A third conducting element is coupled to the current collector plate 220 and to the anode electrode 195 of the battery cell 194. A fourth conducting element is coupled to the current collector plate 320 and to the cathode electrode 196 of the battery cell 194. In an exemplary configuration, the first conducting element includes a battery cell conductor pad 150, a conductor 152, and a current collector conductor pad 154. The second conducting element includes a battery cell conductor pad 200, a conductor 202, and a current collector conductor pad 204. The third conducting element includes a battery cell conductor pad 170, a conductor 172, and a current collector conductor pad 174. The fourth conducting element includes a battery cell conductor pad 210, a conductor 212, and a current collector conductor pad 214. In some embodiments, one some, or all of the conductors 152, 172, 202, and 212 are fusible links or flexible fusible links that melt under excessive current.

Various methods can be used to connect current collector conductor pads to a current collector plate. Methods for connecting current collector conductor pads to a current collector plate include, but are not limited to, resistance welding, laser welding, ultrasonic welding, brazing, soldering mechanical fasteners, and conductive adhesives. Various method can be used to connect a current collector plate to a cooling module. Methods for connecting a current collector conductor plate to a cooling module include, but are not limited to, adhesives, mechanical fasteners, and welding.

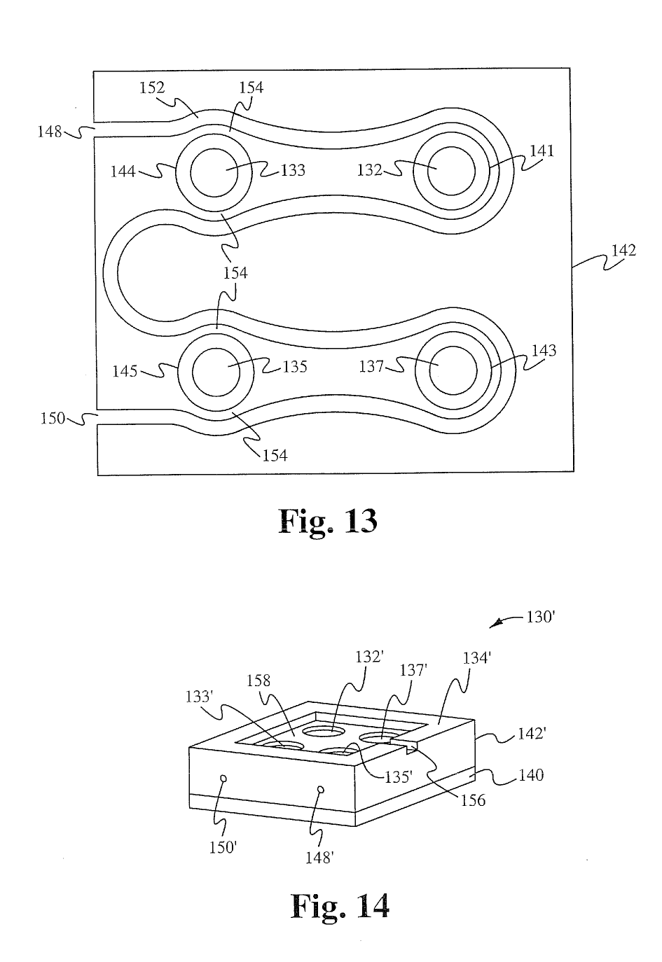

The cooling module 130 includes a cover component 140 coupled to a channel component 142. The cover component 140 and the channel component 142 are configured similarly as the cover component 40 and the channel component 42, respectively, of FIGS. 3-5 except that the openings and channel of the cover component 140 and the channel component 142 are configured for multiple battery cells. FIG. 13 illustrates a bottom up view of the channel component 142 of FIG. 12. A channel 152 includes the liquid inlet port 148 and the liquid outlet port 150. A portion of the channel 152 is positioned proximate the perimeter of each opening 141, 143, 144, and 145 such that a wall 154 is formed between each opening 141, 143,144, and 145 and the channel 152. In some embodiments, each opening 141, 143, 144, and 145 is circular, and the portion of the channel 152 forms a partial ring around a portion of each opening 141, 143,144, and 145. Each of the openings 141, 143, 144, and 145 are analogous to the opening 44 (FIG. 5) in the channel component 42 (FIG. 5). A thickness of the wall 154 is application specific. In some embodiments, the channel is a single continuous channel, as shown in FIG. 13. Alternatively, the channel can include one or more branches that recombine prior to reaching the single liquid outlet port 150. In other embodiments, multiple liquid inlet ports and/or multiple liquid outlet ports are used, and one or more channels, that may or may not include branches, can be configured within the channel component. The cooling module 160 is configured similarly as the cooling module 130.

In operation, liquid flows into the channel 152 via the liquid inlet port 148 and out of the channel 152 via the liquid outlet port 150. The cover component 140 is sealed to the channel component 142 thereby sealing the channel 152 except for the liquid inlet port 148 and the liquid outlet port 150. The channel component 142 is made of a thermally conductive material. As liquid flows through the channel 152, heat from the plurality of battery cells is transferred from the first end of each battery cell to the material of the channel component 142, including the walls 144, and into the liquid flowing through the channel 152. In some embodiments, the liquid inlet port 148 and the liquid outlet port 150 are coupled to a liquid cooling loop whereby heated liquid output through the liquid outlet port 150 is cooled and subsequently input to the liquid inlet port 148.

As shown in FIG. 12, the first current collector plate 220 is positioned on the surface 134 (FIG. 9) of the cooling module 130. In alternative embodiments, an indent can be formed in the surface of the cooling module such that a current collector conductor plate can fit within the indent. In some embodiments, the indent is formed having a perimeter shape that matches the perimeter shape of the current collector plate such that the current collector plate fits securely within the indent. FIG. 14 illustrates an isometric view of a cooling module for multiple battery cells having an indent according to an embodiment. The cooling module 130′ is configured similarly as the cooling module 130 except that an indent 158 is formed in a surface 134′ of the cooling module 130′. As shown in FIG. 14, the exemplary shape of the indent 158 is a square, in which case the current collector plate is shaped as a square to fit within the indent 158. It is understood that alternative shapes and sizes of the indent and current collector plate can be used. In some embodiments, the indent 158 includes a channel 156 to accommodate a complimentary extension in the current collector plate. Such an extension further secures the current collector plate within the indent, as well as provides an electrical connection point.

In some embodiments, only a single cooling module is used, such as the cooling module 130. In this embodiment, a battery cell holder can be used to provide additional structural support. In some embodiments, the battery cell holder can be configured with a step-like form factor at one end to match a contour of the second end of each battery cell, the end of the battery cell holder having openings to expose the second electrode of each battery cell. In such a single cooling module configuration, the second current collector plate is coupled to the surface of the battery cell holder.

Alternative embodiments are directed to replacing the individual conducting elements with a fuse sheet coupled to each current collector plate. In some embodiments, a fuse sheet is a thin foil having one or more layers of an electrically conductive material. An array of conducting elements, such as fusible links or flexible fusible links, can be integrally formed from the fuse sheet. In an exemplary configuration, four conducting elements are formed within a fuse sheet so as to match the four through holes in the current collector plate 120 (FIG. 11), and where appropriate the four openings in the battery cell holder 102 (FIG. 10). The array of conducting elements are positioned to align with the through holes in the current collector plate. In an exemplary configuration, each conducting element includes a conductor and a battery cell conductor pad. An exemplary configuration of a fuse sheet is described in U.S. patent application Ser. No. 12/779,884, filed on May 13, 2010, and titled “Flexible Fusible Link, Systems, and Methods”. The current collector conductive pads of each individual conducting element coupled to the first electrodes, such as the current collector conductive pad 154 in FIG. 12, are collectively replaced by the fuse sheet. The fuse sheet is aligned with a current collector plate so as to align the array of conducting elements with the array of through holes in the current collector plate. The fuse sheet can be coupled to the current collector plate using one of the same methods used to couple the current collector conductive pad to the current collector plate described above.

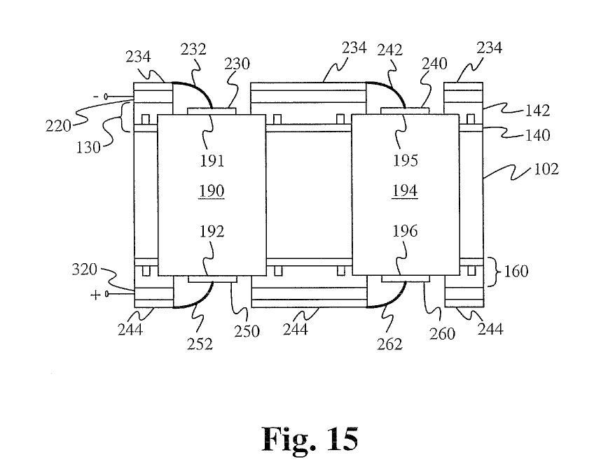

FIG. 15 illustrates a cut out side view of a battery pack including fuse sheets according to an embodiment. The battery pack of FIG. 15 is configured similarly as the battery pack of FIG. 12 except that the conducting elements in FIG. 12 are replaced by fuse sheets. In particular, the battery pack of FIG. 15 includes the battery cell holder 102, the first cooling module 130, the second cooling module 160, the first current collector plate 220, and the second current collector plate 320 of FIG. 12. It is understood that inclusion of the battery cell holder 102 is optional. The battery pack also includes a fuse sheet 234 coupled to the current collector plate 220, and a fuse sheet 244 coupled to the current collector plate 320. The cut out side view shown in FIG. 15 is the same as the cut out side view of FIG. 12 except that the conducting elements including the battery cell conductor pads 150, 170, the current collector conductor pads 154, 174, and the fusible conductors 152, 172 in FIG. 12 are replaced by the fuse sheet 234 having the battery cell conductor pads 230, 240 and the fusible conductors 232, 242, and the conducting elements including the battery cell conductor pads 200, 210, the current collector conductor pads 204, 214, and the fusible conductors 202, 212 in FIG. 12 are replaced by the fuse sheet 244 having the battery cell conductor pads 250, 260 and the fusible conductors 252, 262.

In some embodiments, a fuse sheet having conducting elements is coupled to only one of the two current collector plates, and individual conducting elements of the type shown in FIG. 12 are coupled to the other current collector plate.

The conducting elements and/or the fuse sheet including an array of conducting elements can be fabricated using any conventional manufacturing or fabrication process including, but not limited to, etching, stamping, or laser cutting of thin foils made of materials comprising, for example, aluminum, copper, nickel, zinc, or any combination thereof.

In alternative embodiments, the battery cell holder is not used, and instead, two cooling modules are used as both cooling devices and support structures. As opposed to coupling each of the cooling modules to the battery cell holder, as in the structures of FIGS. 1B and 9, the two cooling modules can be secured to each other. Each end of each battery cell is positioned against one of the cooling modules, as in the structure of FIG. 1A. In some embodiments, mounting stands are positioned between the two cooling modules, and each cooling module is secured to one end of each mounting stand. For example, a mounting stand can be positioned between each corner of the two cooling modules, and each cooling module is secured to one end of each mounting stand at each corner. The cooling modules can be secured to the mounting stands using any conventional securing and/or mounting means.

In other alternative embodiments, the cooling module does not include a cover component. Instead, the channel component of the cooling module is coupled to the battery cell holder and the interfacing surface, for example the surface 4 (FIG. 2) or the surface 104 (FIG. 10), functions as the cover component. In this embodiment, the channel component is coupled to the battery cell holder in a manner similar to coupling the channel component to the cover component.

Embodiments of the battery pack described in relation to FIGS. 11, 12, and 14 are directed to a single anode current collector plate and a single cathode current collector plate. In other embodiments, more than one anode current collector plate and more than one cathode current collector plate can be used. For example, a first anode current collector plate can be coupled to the battery cells in battery cell chambers 116 and 118, and a second anode current collector plate can be coupled to the battery cells in the battery cell chambers 117 and 119.

Embodiments of the battery pack described in relation to FIG. 15 are directed to a single anode-side fuse sheet and a single cathode-side fuse sheet. In other embodiments, more than one anode-side fuse sheet and more than one cathode-side fuse sheet can be used.

It is to be understood that the above description is intended to be illustrative and not restrictive. Many variations of the battery liquid cooling device will be apparent to those of skill in the art upon reviewing the above description. These variations can, for example, include the shape and size of the current collector conductor pad, the shape and size of the battery cell conductor pad, the battery cell form factor, the shape and path of the conductor element, the channel size, contour, and position, the number of channels, and the contact surface area between the ends of each battery cell and the cooling module.

The battery liquid cooling device has been described in terms of specific embodiments incorporating details to facilitate the understanding of the principles of construction and operation of the battery liquid cooling device. Such references, herein, to specific embodiments and details thereof are not intended to limit the scope of the claims appended hereto. It will be apparent to those skilled in the art that modifications can be made in the embodiments chosen for illustration without departing from the spirit and scope of the battery liquid cooling device.

What is claimed is:

1. A battery temperature regulating module comprising:
a. a channel component made of a thermally conductive material, wherein the channel component comprises one or more first openings, each first opening configured to receive an end of a battery cell such that the end of the battery cell is thermally coupled to the channel component, further wherein the channel component further comprises at least one liquid inlet port, at least one liquid outlet port, and one or more channels coupled between the at least one liquid inlet port and the at least one liquid outlet port through which liquid flows such that heat is transferred between the end of the battery cell and the liquid flowing through the one or more channels; and
b. a cover component coupled to the channel component such that the one or more channels are sealed except for the at least one liquid inlet port and the at least one liquid outlet port.

2. The battery temperature regulating module of claim 1 wherein the one or more first openings and the one or more channels are formed on a first surface of the channel component, further wherein the channel component includes a second surface thermally coupled to a current collector element such that heat is transferred between the current collector element and the liquid flowing through the one or more channels.

3. The battery temperature regulating module of claim 2 wherein the channel component further comprises an indent formed in the second surface, wherein the indent is configured to receive the current collector element.

4. The battery temperature regulating module of claim 2 wherein the channel component further comprises a second opening formed in the second surface, wherein the second opening is smaller than the first opening, and the second opening is aligned with the first opening and the first end of the battery cell.

5. The battery temperature regulating module of claim 2 wherein the channel component is sealed to the cover component using one of a group consisting of glue, ultrasonic welding, hot plate welding, and vibration welding.

6. A battery temperature regulating device comprising:
a. a battery cell including a first end having a first electrode and a second end having a second electrode; and
b. a temperature regulating module made of a thermally conductive material, wherein the temperature regulating module comprises a first opening configured to receive the first end of the battery cell such that the first end of the battery cell is thermally coupled to the temperature regulating module, further wherein the temperature regulating module further comprises at least one liquid inlet port, at least one liquid outlet port, and one or more channels coupled between the at least one liquid inlet port and the at least one liquid outlet port, heat is transferred between the first end of the battery cell and a liquid flowing through the one or more channels.

7. The battery temperature regulating device of claim 6 further comprising a battery cell holder configured to support the battery cell, wherein the battery cell holder is coupled to the temperature regulating module.

8. The battery temperature regulating device of claim 7 wherein the first end of the battery cell extends out of the battery cell holder.

9. The battery temperature regulating device of claim 6 further comprising a first current collector element electrically coupled to the first electrode of the battery cell, and a second current collector element electrically coupled to the second electrode of the battery cell.

10. The battery temperature regulating device of claim 9 wherein the first current collector element is thermally coupled to the temperature regulating module such that heat is transferred between the first current collector element and the liquid flowing through the one or more channels in the temperature regulating module.

11. The battery temperature regulating device of claim 9 wherein the first current collector element comprises a current collector conductor pad, a current collector conductor plate, a current collector conductor fuse sheet, or any combination thereof.

12. The battery temperature regulating device of claim 9 wherein the temperature regulating module includes a first surface having an indent configured to receive the first current collector element.

13. The battery temperature regulating device of claim 9 wherein the first current collector element is coupled to a first output terminal, and the second current collector conductive element is coupled to a second output terminal.

14. The battery temperature regulating device of claim 6 wherein the temperature regulating module comprises a first surface including the first opening and a second surface opposite the first surface, the second surface including a second opening smaller than the first opening, wherein the second opening is aligned with first electrode of the battery cell.

15. The battery temperature regulating device of claim 6 wherein the temperature regulating module comprises a channel component including the at least one liquid inlet port, the at least one liquid outlet port, and the one or more channels, and a cover component sealed to the channel component such that the one or more channels are sealed except for the at least one liquid inlet port and the at least one liquid outlet port.

16. The battery temperature regulating device of claim 15 wherein the channel component is sealed to the cover component using one of a group consisting of glue, ultrasonic welding, hot plate welding, and vibration welding.

17. The battery temperature regulating device of claim 6 further comprising a second temperature regulating module made of a thermally conductive material, wherein the second temperature regulating module comprises a first opening configured to receive the second end of the battery cell such that the second end of the battery cell is thermally coupled to the second temperature regulating module, further wherein the second temperature regulating module further comprises at least one liquid inlet port, at least one liquid outlet port, and one or more channels coupled between the at least one liquid inlet port and the at least one liquid outlet port, heat is transferred between the second end of the battery cell and a liquid flowing through the one or more channels in the second temperature regulating module.

18. The battery temperature regulating device of claim 17 further comprising a battery cell holder configured to support the battery cell, wherein the battery cell holder is coupled to the temperature regulating module and the second temperature regulating module.

19. The battery temperature regulating device of claim 18 wherein the second end of the battery cell extends out of the battery cell holder and into the corresponding first opening of the second temperature regulating module.

20. A battery pack comprising;
a. a plurality of battery cells, each battery cell including a first end having a first electrode and a second end having a second electrode; and
b. a temperature regulating module made of a thermally conductive material, wherein the temperature regulating module comprises a plurality of first openings, each first opening configured to receive the first end of a corresponding one of the plurality of battery cells such that the first end of each battery cell is thermally coupled to the temperature regulating module, further wherein the temperature regulating module further comprises at least one liquid inlet port, at least one liquid outlet port, and one or more channels coupled between the at least one liquid inlet port and the at least one liquid outlet port, heat is transferred between the first end of each battery cell and a liquid flowing through the one or more channels.

21. The battery pack of claim 20 further comprising a battery cell holder configured to support the plurality of battery cells, wherein the battery cell holder is coupled to the temperature regulating module.

22. The battery pack of claim 21 wherein the first end of each battery cell extends out of the battery cell holder.

23. The battery pack of claim 20 further comprising a first current collector element electrically coupled to the first electrode of each of plurality of battery cells, and a second current collector element electrically coupled to the second electrode of each of the plurality of battery cells.

24. The battery pack of claim 23 wherein the first current collector element is thermally coupled to the temperature regulating module such that heat is transferred between the first current collector element and the liquid flowing through the one or more channels in the temperature regulating module.

25. The battery pack of claim 23 wherein the first current collector element comprises a plurality of current collector conductor pads, one or more current collector conductor plates, one or more current collector conductor fuse sheets, or any combination thereof.

26. The battery pack of claim 23 wherein the temperature regulating module includes a first surface having an indent configured to receive the first current collector element.

27. The battery pack of claim 23 wherein the first current collector element is coupled to a first output terminal, and the second current collector element is coupled to a second output terminal.

28. The battery pack of claim 20 wherein the temperature regulating module comprises a first surface including the plurality of first openings and a second surface opposite the first surface, the second surface including a plurality of second openings, each second opening is smaller than the first openings, wherein each of the plurality of second openings is aligned with a corresponding one of the first electrodes of the plurality of battery cells.

29. The battery pack of claim 20 wherein the temperature regulating module comprises a channel component including the at least one liquid inlet port, the at least one liquid outlet port, and the one or more channels, and a cover component sealed to the channel component such that the one or more channels are sealed except for the at least one liquid inlet port and the at least one liquid outlet port.

30. The battery pack of claim 29 wherein the channel component is sealed to the cover component using one of a group consisting of glue, ultrasonic welding, hot plate welding, and vibration welding.

31. The battery pack of claim 20 further comprising a second temperature regulating module made of a thermally conductive material, wherein the second temperature regulating module comprises a plurality of first openings configured to receive the second end of a corresponding one of the plurality of battery cells such that the second end of each battery cell is thermally coupled to the second temperature regulating module, further wherein the temperature regulating module further comprises at least one liquid inlet port, at least one liquid outlet port, and one or more channels coupled between the at least one liquid inlet port and the at least one liquid outlet port, heat is transferred between the second end of each of the plurality of battery cells and a liquid flowing through the one or more channels in the second temperature regulating module.

32. The battery pack of claim 31 further comprising a battery cell holder configured to support the plurality of battery cells, wherein the battery cell holder is coupled to the temperature regulating module and the second temperature regulating module.

33. The battery pack of claim 32 wherein the second end of each of the plurality of battery cells extends out of the battery cell holder and into the corresponding first opening of the second temperature regulating module.
